(19) United States
(12) Patent Application Publication
(10) Pub. No.: US 2004/0144020 A1
(43) Pub. Date: Jul. 29, 2004

(54) Hybrids of the wild mushroom strain RWK1913

(76) Inventors: Richard W. Kerrigan, Worthington, PA (US); Mark Peter Wach, Allison Park, PA (US)

Correspondence Address: RENNER, KENNER, GREIVE, BOBAK, TAYLOR & WEBER, FOURTH FLOOR, FIRST NATIONAL TOWER, AKRON, OH, 44308, US

(21) Appl. No.: 10/745,873

(22) Filed: Dec. 24, 2003

Related U.S. Application Data
(60) Provisional application No. 60/440,297, filed on Jan. 15, 2003.

(51) Int. Cl. A01G 1/04

(52) U.S. Cl. 47/1.1

(57) ABSTRACT

A novel hybrid mushroom culture of Agaricus bisporus, and its inbred and outcrossed descendants, is produced by crossing a culture of a wild strain of Agaricus bisporus designated RWK 1913 with a second culture of a different, preferably cultivated, strain of Agaricus bisporus. Where the second culture is the known cultivated strain designated S130-b, a novel hybrid mushroom culture designated B7970 is formed.

### CROSS REFERENCE TO RELATED APPLICATIONS

This application claims the benefit of U.S. Provisional Application Serial No. 60/440,297, filed Jan. 15, 2003.

### TECHNICAL FIELD

This invention relates to a novel class of hybrid cultures of the edible, cultivated mushroom fungus Agaricus bisporus (Lange) Imbach var. bisporus. More particularly, this invention relates to cultures that are hybrids of or descended from a newly discovered wild strain of the mushroom, designated RWK 1913, and various strains of Agaricus bisporus (Lange) Imbach var. bisporus.

### BACKGROUND OF THE INVENTION

The edible mushroom Agaricus bisporus (Lange) Imbach var. bisporus, a basidiomycete fungus, is widely cultivated around the world. In Europe and North America, it is the most widely cultivated mushroom species. The value of the annual Agaricus bisporus mushroom crop in the United States was about $912,000,000 in 2001-2002, according to the National Agricultural Statistics Service, Agricultural Statistics Board, U.S. Department of Agriculture (Aug. 16, 2002). More than 90 percent of the Agaricus mushrooms cultivated in the United States, Europe, and elsewhere have a white pileus color, in accordance with consumer preferences.

Approximately 20 years ago, the first two white hybrid strains of A. bisporus, developed by a laboratory at Horst, the Netherlands, were introduced into commercial cultivation. These two “Horst” strains, called U1 and U3, are closely related crosses between two pre-existing white cultivated strains, as per M. Imbernon et al., Mycologia, 88(5), 749-761 (1996), herein incorporated by reference. The U1 and U3 strains, while still cultivated at present, are additionally the direct progenitors of all other white A. bisporus mushrooms currently cultivated in most developed regions of the world. Commercial mushroom strains derived from U1 and U3 are all either clones or quasi-clones of U1 or U3, being derived either by clonal vegetative propagation or from spores which retain the great majority of the parental genotype, as shown by R. W. Kerrigan et al. in Genetics, 133, 225-236 (1993), herein incorporated by reference. A group of strains derived either by cloning or by spore propagation, or both, from a single progenitor (as opposed to outcrossing between two different progenitors) is called a lineage group. Except for minor acquired genetic differences all derived white strains in the Horst U1 lineage group and Horst U3 lineage group share a single basic genotype with the original U1 or U3 strains, respectively (which are themselves very similar, due to their close relationship). For these reasons, and the fact that the Horst U3 lineage group is presently cultivated to a much smaller extent than the Horst U1 lineage group, modern white Agaricus mushroom cultivation is effectively a monoculture. Hence, for purposes of this disclosure, all of these cultivar strains will be described hereinafter as the “Horst U1/U3 lineage group” where both the Horst U1 lineage group and Horst U3 lineage group are implied.

Currently, the most commercially successful representative of the Horst U1/U3 lineage group is a strain designated A15 by the assignee of record. That strain, specifically, is from the Horst U1 lineage group.

The introduction of new varieties of white Agaricus bisporus mushrooms into commercial culture has been impeded by three difficulties. First, cross-breeding strains of Agaricus bisporus var. bisporus can be difficult and cumbersome. U.S. Pat. No. 5,304,721 sets forth many of the problems associated with cross-breeding. Second, experience indicates that most wild germ plasm resources for this species exhibit various traits that would be unacceptable in the marketplace. Third, most of these germ plasm resources incorporate alleles that give rise to brown mushrooms, which are in less demand by consumers than are white mushrooms. Color is predominately determined by alleles at the Ppc-1 locus; see P. Callac et al., Fungal genetics and Biology, 23(2): 181-188 (1996), herein incorporated by reference. Alleles providing the white color trait are rare to relatively uncommon in most wild populations of A. bisporus. Of approximately 150 wild Agaricus bisporus mushroom strains collected in coastal California, only 2 were white, while the rest were brown, as seen in, inter alia, R. W. Kerrigan and I K. Ross, Mycologia, 81(3):433-443 (1989), R. W. Kerrigan et al., Molecular Ecology, 7:35-45 (1999).

The difficult nature of breeding a commercially successful hybrid variety of A. bisporus is illustrated by the fact that very few patent applications for novel hybrid Agaricus bisporus strains have been filed in the United States; of these, only one (i.e., assignee of record's brown hybrid strain X618, marketed as S600) enjoyed even moderate commercial success. It is believed that no hybrid white mushrooms other than U1 and U3 have heretofore ever been successfully introduced into commerce in the United States.

There is a wide range of potential benefits to introducing greater diversity of strains into commercial cultivation. Novel strains may exhibit novel patterns of nutritional resource utilization, different responses to environmental manipulation, precocity or different developmental schedules, and novel aesthetic and culinary properties for the consumer. Examples of traits favored by the consumer could include a more attractive shape (i.e., more round) or a greater development of pileus tissue (i.e., greater “meatiness” or thickness). Some of these benefits may become apparent only after years of cultivation and marketing experience, for example, if a novel crop pathogen emerges. New strains may offer improved resistance to known and emerging diseases of the crop; in particular they are very likely to be much less susceptible to infection by established viral diseases that are transmitted by anastomosis (i.e., the fusion of fungal cells, called hyphae). For a more detailed description of anastomosis and of some viral diseases to which basidiomycete fungi are susceptible, see A. S. M. Sonnenberg et al., Mushroom Science 14, 587-594 (1995), herein incorporated by reference.

Viral diseases such as LIV have had a serious impact on commercial Agaricus mushroom production in the latter half of the twentieth century. In recent years, new patterns of Agaricus mushroom crop abnormalities in northern Europe, associated with the presence of novel dsRNA molecules, have indicated that new virus diseases are continuing to emerge in commercial cultivation facilities. The economic impact of the ‘Virus X disease’ in the U.K. has been severe, precipitating several business failures while injuring surviving producers in the last four years. There is a need for commercially acceptable strains of Agaricus bisporus that have a reduced susceptibility either to infection by viruses established in living material of Horst U1/U3 lineage group strains, or to the consequences of the presence of viruses following successful infection.

### SUMMARY OF THE INVENTION

Broadly, the present invention is directed to a new and distinct class of Agaricus bisporus mushroom cultures descended from a newly discovered wild strain of Agaricus bisporus, designated RWK 1913, via hybridization of (1) the RWK 1913 strain or (2) hybrid strains descended from the RWK 1913 strain. Thus, the present invention encompasses all hybrid fungus cultures descended from RWK 1913, including first generation hybrid cultures and any further hybrid cultures produced by the progeny of RWK 1913. In a more preferred embodiment of the invention, the RWK 1913 strain, or strains descended therefrom, may be crossed with a strain of, or a strain descended from, the Horst U1/U3 lineage group to form several distinct novel hybrid cultures, including a new hybrid culture designated B7970.

The advantages of the present invention over existing prior art relating to Agaricus bisporus mushrooms and cultures, which shall become apparent from the description which follows, are accomplished by the invention as hereinafter described and claimed.

In general, one or more aspects of the present invention may be accomplished by a hybrid fungus culture of Agaricus bisporus produced by crossing a first culture of Agaricus bisporus with a second culture of Agaricus bisporus, wherein one of said first and said second cultures of Agaricus bisporus is a fungus strain designated RWK 1913 or a fungus strain descended from said strain RWK 1913, a representative culture of said strain RWK 1913 having been deposited under ATCC Accession No. PTA-4888.

One or more other aspects of the present invention may be accomplished by a culture of a fungus strain designated B7970, a representative culture of said fungus strain having been deposited under ATCC Accession No. PTA-4887.

Advantageously, it has been found that many of the hybrid cultures produced as the present invention exhibit commercially acceptable physical and performance characteristics. For example, one or more hybrid cultures may have the ability to produce mushrooms having rounded and/or thick-fleshed and/or white pileii. These or other hybrid cultures may exhibit antagonism toward strains in the Horst U1/U3 lineage group, and consequently be less susceptible to transmission of viral diseases by contact with infected cultures of the Horst U1/U3 lineage group. These or still other cultures may be less likely to exhibit symptoms of viral infection if they become infected. The pileus color of mushrooms produced by fruiting of the cultures of this class of fungi may be white or brown, depending upon which of two alternate alleles is inherited from strain RWK 1913.

### PREFERRED EMBODIMENT FOR CARRYING OUT THE INVENTION

As noted hereinabove, the present invention relates to cultures descended from a newly discovered wild strain of the mushroom fungus Agaricus bisporus, designated RWK 1913, via hybridization of either the RWK 1913 strain itself, or hybrid strains descended from the RWK 1913 strain, to a second strain of the species. It will be understood that the term “descended” is specifically intended to mean genealogically descended from the strain rather than evolutionary descent, i.e., a naturally occurring process of genetic divergence typically involving at least hundreds of generations and thousands of years. Also, it will be understood that the terms “strain,” “culture,” and “variety” can be used essentially interchangeably for this invention, but attempts have been made to maintain a distinction between the terms based on context. For purposes of this invention, “strain” has been generally used when discussing the more abstract, genealogical composition of matter; “culture” has been generally used when discussing the actual physical embodiment of the composition of matter to be grown typically on a sterile medium; and “var.” (i.e. “variety”) has been generally used when discussing the particular taxonomic variety of Agaricus bisporus. The term “variety,” as used in many U.S. plant patents, is essentially equivalent to “strain.”

A deposit of wild strain RWK 1913, as disclosed herein and recited in the appended claims, has been made with the American Type Culture Collection (ATCC), 10801 University Boulevard, Manassas, Va. 20110. The date of deposit was Jan. 7, 2003. The culture deposited was taken from the same culture maintained by Sylvan America, Inc., Kittanning, Pa., the assignee of record, since prior to the filing date of this application. All restrictions upon the deposit have been removed, and the deposit is intended to meet all deposit requirements of the U.S. Patent and Trademark Office, including 37 C.F.R. Sec. 1.801-1.809, and all deposit requirements under the Budapest Treaty. The ATCC Accession No. is PTA-4888. The deposit will be maintained in the depository for a period of 30 years, or 5 years after the last request, or for the effective life of the patent, whichever is longer, and will be replaced as necessary during that period.

Hybridization of Agaricus bisporus cultures of the invention may be accomplished by allowing two different cultures, one of which is strain RWK 1913 or a strain descended from the strain RWK 1913, to grow together in close proximity, preferably on sterile media, until anastomosis (i.e., hyphal or cell fusion) occurs. Where two compatible nuclei (i.e., two nuclei carrying different alleles at the Mat locus which determines mating type) are present in a fusion cell, they jointly proliferate and establish a growing heterokaryotic culture. This process is commonly known as crossing. Where each of the two nuclei in the resulting heterokaryotic culture was contributed by a different parental strain participating in the fusion process, then the new heterokaryon is a first-generation outcrossed hybrid offspring of the two parents. That is, where the RWK 1913 strain is one of the parental strains and is crossed with a parental strain of another Agaricus bisporus species, the resultant hybrid is a first-generation outcrossed hybrid culture defined as one embodiment of the present invention.

Unlike homokaryons, described below, heterokaryon cultures are capable of producing mushrooms and are routinely incorporated into commercial products such as mushroom spawn and casing inoculant as described below. They can also serve as the progenitors of future generations of inbred and outcrossed descendants. Thus, the present invention provides for the crossing of strains descended from the RWK 1913 strain as well. Inbred is used broadly here to include self-fertilized heterokaryon progeny from spores of a single parent as well as offspring between a hybrid and one of its own progenitors.

The preferred method of hybridization uses two haploid strains (i.e., homokaryons), one being derived from each non-haploid (i.e., heterokaryotic) parental strain. Haploid strains, which incorporate only a single type of nucleus, hybridize with a higher frequency of success, and produce offspring with only a single, predictable, nuclear genotype, in contrast to fusions involving heterokaryons. Homokaryons may be derived from parental strains via several methods including generation of protoplasts, isolation of hyphal tips, or from germinated spores. The latter method provides homokaryons with diverse genotypes, as a result of meiotic recombination during sporogenesis.

In the present invention, homokaryons from the wild strain RWK 1913 were crossed with or otherwise hybridized to a number of different homokaryons, a majority of which were derived from the Horst U1/U3 lineage group. In one embodiment, a homokaryon from the RWK 1913 strain was crossed with a homokaryon from an S130 strain to produce a novel hybrid strain now designated B7970. Strain S130 is a member of the Horst U1/U3 lineage group. The resultant hybrids were then characterized and tested as more fully described below.

A deposit of hybrid mushroom cultivar B7970, as disclosed herein and recited in the appended claims, has been made with the American Type Culture Collection (ATCC), 10801 University Boulevard, Manassas, Va. 20110. The date of deposit was Jan. 7, 2003. The culture deposited was taken from the same culture maintained by Sylvan America, Inc., Kittanning, Pa., the assignee of record, since prior to the filing date of this application. All restrictions upon the deposit have been removed, and the deposit is intended to meet all deposit requirements of the U.S. Patent and Trademark Office, including 37 C.F.R. Sec. 1.801-1.809, and all deposit requirements under the Budapest Treaty. The ATCC Accession No. is PTA-4887. The deposit will be maintained in the depository for a period of 30 years, or 5 years after the last request, or for the effective life of the patent, whichever is longer, and will be replaced as necessary during that period.

If not already explicit, it will further be appreciated that hydridization can further occur between two different Agaricus bisporus cultures wherein one of the cultures is the B7970 strain or descended from the B7970 strain. Thus, all progeny of the B7970 strain may be used in further crosses.

Returning to the wild strain employed in the present invention, wild strain RWK 1913 was screened prior to hybridization for useful traits by cultivating a test crop of the strain. The selected strain was used to generate homokaryons that could then be used in test hybridizations, permitting further evaluation of the wild strain as a source of useful genetic novelty leading to useful traits. Unexpected traits emerged during this process. For example, rarely, a brown parental strain can produce white offspring, due to the transmission into the hybrid of an unsuspected recessive Ppc-1 allele for white color. It has been unexpectedly found that the RWK 1913 strain, a brown strain, can produce white offspring as discussed in greater detail below.

Agaricus mushrooms are customarily produced according to the following process, although any method known in the art for fruiting the cultures can be employed. A pure culture incorporating a single mushroom strain is clonally propagated on a sterile medium. This culture is a mycelium comprising many microscopic, threadlike elements called hyphae, which are themselves composed of cellular compartments. For commercial purposes, some of the pure culture is transferred to a larger volume of an appropriate medium which, when fully grown, can be used as inoculum to produce commercial products such as spawn and casing inoculant (technically all forms of the pure culture are inoculum in a broad sense). Mushroom spawn is usually prepared from a sterilized cooked grain such as rye, wheat, or millet, which may be amended with other materials such as chalk. Casing inoculant is typically composed of particulate matter such as peat moss, vermiculite, and/or compost, blended with some nutrients and moistened with water. A small volume of inoculum is mixed with a larger volume of sterilized grain (for spawn) or other substrate (for casing inoculant). When the pure culture mycelium has grown throughout and fully colonized the larger volume of sterilized substrate, the resulting mass of substrate plus mycelium is now a conventional commercial product, either spawn or casing inoculum.

To produce a crop of mushrooms, the mushroom farmer combines a small volume of mushroom spawn with a larger volume of pasteurized compost in a purpose built structure. Conventional compost is prepared from straw plus water, one or more nitrogen sources, and inorganic calcium sources. Preparation of compost typically takes two to three weeks, culminating in a period at elevated temperatures sufficient to kill invertebrates and many undesirable fungi and bacteria. Once spawned, about two weeks are required for the compost to become fully colonized by the mycelium. At this stage, a layer of porous, absorbent, low-nutrient material such as soil or peat moss is placed over the compost to a depth of about 2 inches. This layer, called the “casing,” may preferentially incorporate casing inoculant or another source of mushroom mycelium such as colonized compost, to speed and enhance the crop. It is important to use the same strain in the spawn/compost and the casing inoculant. Development of the mushroom mycelium in the casing, and formation of mycelial strands and mushroom primordia, takes approximately one week. Subsequently the mushrooms will enlarge during the fruiting process, which requires about one more week to produce mushrooms mature enough for harvest and sale. Additional crops, called flushes or breaks, will be produced at approximately weekly intervals. Modem farmers find that taking three flushes is most profitable.

In order to demonstrate practice of the invention, five homokaryons of strain RWK 1913 were obtained from germinating spores. These five homokaryons were then individually hybridized to a group of 14 “tester” homokaryons, 12 of which were derived from the Horst U1/U3 lineage group. Hybridization produced viable heterokaryons in 47 of 51 instances (17 potential hybrids were not attempted). In a specific example, and as one preferred embodiment of the present invention, homokaryon RWK 1913-s3 was crossed with homokaryon S130-b, a member of the Horst U1/U3 lineage group, to produce the novel hybrid strain B7970. Spawn of these 47 hybrids was prepared and used to produce test crops. Upon evaluation it was noted that three of the five RWK 1913 homokaryons produced white hybrids when hybridized with members of the Horst U1/U3 lineage group; the other two RWK 1913 homokaryons produced brown mushrooms, indicating that RWK 1913 was heterozygous for white and brown alleles at the Ppc-1 locus.

It was further noted that several of the new hybrids appeared to have commercially acceptable properties. The best of these, including hybrid B7970, were evaluated in further crops. B7970 exhibits commercially acceptable performance and physical characteristics, and exemplifies several useful traits, as discussed below.

New hybrid strain B7970 produces white mushrooms having a pileus shape different than that of mushrooms produced by the Horst U1/U3 group. The mushrooms of B7970 are more rounded and have proportionately thicker pileus context (i.e., “flesh”) relative to mushrooms produced by members of the Horst U1/U3 lineage group, including A15. Measurements were performed on the B7970 strain and on the control A15 strain, which is the assignee's most popular commercial strain in the Horst U1/U3 lineage group. Mushrooms were fruited and harvested according to standard practices, thus the relative maturity of mushrooms of both strains was equivalent. Data were gathered from 20 randomly-selected harvested mushrooms of each strain. Harvested mushrooms were sectioned vertically into two equal and symmetrical halves, to permit direct measurement. Four measurements are indicative of the distinct proportions of B7970 mushrooms. (1) ‘Cap Flesh Thickness’ (CFT) is the vertical distance from the top of the lamellae (i.e., gills) adjacent to the stipe, to the surface of the pileus directly above. (2) ‘Cap Fleshiness’ (CF) is calculated as CFT divided by ‘Cap Width’ (CW), the latter being the greatest horizontal distance between two vertical lines tangential to either side of the cap. (3) ‘Cap Height’ (CH) is the vertical distance between two lines that are horizontal and tangential to the lowest and highest portions of the cap, respectively. (4) ‘Cap Roundness’ (CR) is calculated here as CH/CW. A t-test was used to assess the statistical significance of the observed differences. These data are summarized in TABLE I set forth hereinbelow.

TABLE I
Measurements of Mushroom Size and Shape

| | Mean, | | p value | B7970: |
|---|---|---|---|---|
| Measure | B7970TC | Mean, A15 | t-test | A15 |
| Cap Flesh Thickness (CFT) | 14.8 mm | 13.85 mm | 0.011 | +6.9% |
| Cap Fleshiness | 0.313 | 0.297 | (0.07) | +5.4% |
| (CF = CT/CW) | | | | |
| Cap Height (CH) | 27.7 mm | 24.6 mm | 0.00018 | +12.6% |
| Cap Roundness | 0.584 | 0.526 | 0.00001 | +11.0% |
| (CR = CH/CW) | | | | |

These four measures show that Cap Flesh Thickness, Cap Height, and Cap Roundness are all significantly greater in B7970 than in the Horst U1/U3 lineage group as represented by A15. The rounder shape of the cap is apparent and may present a more attractive appearance to the consumer. The thicker flesh of the cap is likely to be appreciated as a desirable culinary trait.

Hybrid strain B7970 exhibits antagonism toward the Horst U1/U3 lineage group exemplified by strain A15. By “antagonism,” it is meant that the two strains cannot cooperate to produce a normal crop of mushrooms. This is theoretically due to an inability of the two strains to freely anastomose due to genetic differences at postulated vegetative incompatibility (VI) loci; VI systems apparently function in all basidiomycetes as self/nonself recognition systems, probably as a defense mechanism, but are poorly understood at the genetic level. Empirically, VI can be demonstrated by placing one strain in compost and a second strain above it in a layer of peat moss, soil, or other non-nutritive matter known as the ‘casing’. If the two strains are compatible, cell fusions (anastomosis) occur and nutrients are transported through the integrated cell mass (mycelium) to produce a normal crop of mushrooms at the top of the casing layer. If, however, VI exists between the two strains, cell fusions do not succeed, nutrient flow is blocked, and reduced yield and/or delayed appearance of the crop are observed. This is significant because intracellular diseases of the crop, such as dsRNA viruses, are spread through cell contact and successful cell fusion; the VI system protects against such infection by blocking successful cell fusion, restricting the spread of intracellular diseases between individuals.

In a test of the four possible combinations of strains B7970 and A15, conducted in small trays having a casing surface area of 2.75 square feet, VI interference with the crop was evident, as shown in TABLE II hereinbelow.

TABLE II
Cumulative daily yield of mushrooms

| | | Grams of mushrooms | | | | |
|---|---|---|---|---|---|---|
| Treatment: | | harvested through day | | | | |
| Compost | Casing | 14 | 15 | 16 | 17 | 18 |
| B7970 | B7970 (self) | 0 | 1252 | 1423 | 1449 | 1449 |
| B7970 | A15 (nonself) | 0 | 480 | 560 | 824 | 824 |
| A15 | B7970 (nonself) | 0 | 240 | 318 | 318 | 318 |
| A15 | A15 (self) | 0 | 0 | 712 | 1186 | 1278 |

A reduction of yield in nonself treatments relative to self treatments is evident in TABLE II. A drawback of the small tray format used in that test is that edge effects compromise the two-layered structure of the compost/casing interface, minimizing the observable effects of VI interference. In other words, antagonism between B7970 and A15 may be understated by the data in TABLE II. A larger format test comprising 120 square feet of B7970 over A15 and 120 square feet of A15 over B7970 was subsequently conducted. In this second test, we observed that more than 95% (estimated) of the crop was lost in either configuration. Losses due to interstrain antagonism were so severe that the test was terminated after being photographed but without formally obtaining quantitative data. From these two tests we conclude that anastomosis between B7970 and strains such as A15 in the Horst U1/U3 lineage group will be limited at best. Based on what is known about VI systems in basidiomycete mushrooms, it is reasonable to expect that similar interstrain antagonism will be a feature of most if not all members of the claimed class. It follows that transmission of intracellular diseases such as dsRNA viruses from infected material of the Horst U1/U3 strain group, which presently form reservoirs of viral infection on many farms, to B7970 and related strains will be restricted or possibly even prevented by this interstrain antagonism.

An infectivity test was conducted to examine the transmissibility of the putative ‘Virus X’ disease that recently became established in the U.K. Trays of approximately 1 m surface area were inoculated with spawn of either B7970 or A15, such that spawn was homogeneously distributed within the compost. Concurrently a small amount of ‘Virus X’-infected spawn, equal to 1% of total spawn, was placed in a 1 cm diameter hole formed in the compost near one end of each tray. Two trays spawned with B7970 showed little or no effect from the infectious material, and crops were produced on schedule (“flushes” of mushrooms typically appear at 7-10 day intervals). In contrast, the entire tray of A15 showed a characteristic major effect of ‘Virus X’ infection, including reduced production and an off color, and crops were substantially delayed, as shown in TABLE III hereinbelow.

TABLE III
Effect of ‘Virus X’ infection via U1/U3-type
source material on crops of B7970 and A15

| | Days following application of | | |
|---|---|---|---|
| | casing layer until last harvest of | | |
| | Flush 1 | Flush 2 | Flush 3 |
| B7970 (infected) | 18 | 27-28 | 38 |
| A15 (infected) | 21 | 31 | 42-49 |

The results clearly demonstrated that B7970 has a substantially reduced susceptibility to ‘Virus X’ infection (from Horst U1/U3 disease reservoirs) relative to the Horst U1/U3 lineage group as represented by A15. This is theoretically due at least in part to antagonism between B7970 and Horst U1/U3 lineage group type strains. Whether there are also additional mechanisms in B7970 that mitigate infection, or the effects of infection, remains to be determined.

As a consequence of having wild strain RWK 1913 as a parent, B7970 and all related hybrid strains belonging to the class of the invention carry distinctive genetic markers not found in the Horst U1/U3 lineage group nor in other disclosed strains. For example, the new hybrid variety B7970 has a novel allozyme genotype. Allozyme methods and allelic nomenclature are given in R. W. Kerrigan and I. K. Ross, Mycologia, 81(3):433-443 (1989). TABLE IV provides examples of allozyme phenotypic differences between B7970 and other cultivar and recorded hybrid strains. Other genetic markers also distinguish the new variety from other cultivars. SCAR markers PR2 and PR6 are disclosed in Callac et al., FEMS Microbiol. Letters 146: 235-240 (1997), herein incorporated by reference. TABLE V provides examples of some genotypic differences that distinguish B7970 from other cultivated white Agaricus bisporus mushrooms (the Horst U1/U3 lineage group, including strains A15 and S130) currently marketed in the United States.

TABLE IV
Allozyme genotypes of B7970, U1/U3,
and three patented strains

| Allozyme | Strain: | | | | |
|---|---|---|---|---|---|
| marker: | B7970 | U1/U3 group | BB32 | S600 | AA-0028 |
| Pep2 | 2/3 | ¾ | ¾ | ¾ | ⅓, 3/3, ¼ or ¾ |
| BGlu | 3/4 | ⅘ | NA | ⅘ | ¾ or ⅗ |

Note that allozyme genotypes of BB32 and AA-0028 were not fully disclosed but can be delimited based on published information in conjunction with our proprietary data on the progenitors of each strain. Alleles in bold type in TABLE IV distinguish B7970 from the Horst U1/U3 lineage group.

TABLE V
SCAR marker genotypes of B7970 and
three contemporary commercial strains

Strain:

| SCAR marker: | B7970 | U1/U3 group | S600 | SB65 |
|---|---|---|---|---|
| pr2r-285 | + | − | + | + |
| pr2r-200 | + | − | + | + |
| pr6h-590 | − | + | − | + |
| pr6h-570 | + | − | − | − |
| pr6h-490 | − | + | − | + |

From TABLE IV and TABLE V it is clear that B7970 can be distinguished from other disclosed and currently marketed strains of Agaricus bisporus by its genotype, in addition to the other distinctive characteristics discussed hereinabove. Data presented herein is non-limiting as these are only examples of useful markers; several others have been documented. It is important to note that all hybrids belonging to the invented class will have novel genotypes due to the presence of genetic material from RWK 1913; however those genotypes may differ from the example of B7970 presented above. Further, in subsequent outcrossed, backcrosses, and selfed generations the proportion of genetic material and markers from B7970 may change. In selfed progeny, a heterozygous marker may become homozygous, producing the appearance of a novel genotype, whereas in actuality a nearly complete subset of the original genotype will be present. For these reasons, although genetic markers can readily identify members of the invented class, and genotypes will normally remain stable attributes of individual strains within the class, no specific genotype is represented to be an invariable attribute of the class as a whole.

In order to further demonstrate practice of the invention, six homokaryons were obtained from single spores of hybrid strain B7970. These six homokaryons were crossed in all combinations with 7 homokaryons obtained from other strains, one of which was a member of the Horst U1/U3 lineage group. The 42 resulting hybrids can be evaluated for economically valuable traits as described above.

Based on the foregoing disclosure, it should now be apparent that producing novel Agaricus bisporus mushroom strains by enabling hybridization between wild strain RWK 1913 and cultivated strains of Agaricus bisporus, including those strains belonging to the Horst U1/U3 lineage group, will carry out the objects of the present invention. In addition to commercially acceptable characteristics, some of these hybrid strains will have other commercially valuable characteristics, such as a rounder cap, thicker cap tissue, and antagonisim to stains of the Horst U1/U3 group, leading to reduced susceptibility to viral diseases such as ‘Virus X’. Hybrids belonging to this class can be produced by various means, including those disclosed above. It is to be understood that any variations evident fall within the scope of the claimed invention and thus, the selection of specific hybridization techniques and sources of homokaryons and heterokaryons can be determined without departing from the spirit of the invention herein disclosed and described. Thus, the scope of the invention shall include all modifications and variations that may fall within the scope of the attached claims.

What is claimed is:

1. A hybrid mushroom culture of Agaricus bisporus produced by crossing a first culture of Agaricus bisporus with a second culture of Agaricus bisporus, wherein one of said first and said second cultures of Agaricus bisporus is a wild strain designated RWK 1913 or a strain descended from said wild strain RWK 1913, a representative culture of said wild strain RWK 1913 having been deposited under ATCC Accession No. PTA-4888.

2. The hybrid mushroom culture of claim 1, wherein the other of said first and said second cultures of Agaricus bisporus is a culture selected from strains of a Horst U1/U3 lineage group.

3. The hybrid mushroom culture of claim 1, wherein said hybrid mushroom culture is capable of producing mushrooms having a brown color.

4. The hybrid mushroom culture of claim 1, wherein said hybrid mushroom culture is capable of producing mushrooms having a white color.

5. The hybrid mushroom culture of claim 1, wherein said hybrid mushroom culture is capable of producing mushrooms having more rounded pileii than pileii of mushrooms produced from cultures belonging to an Agaricus bisporus strain designated A15.

6. The hybrid mushroom culture of claim 1, wherein said hybrid mushroom culture is capable of producing mushrooms having pileii with thicker flesh than pileii of mushrooms produced from cultures belonging to an Agaricus bisporus strain designated A15.

7. The hybrid mushroom culture of claim 1, wherein said hybrid mushroom culture exhibits antagonism toward strains in a Horst U1/U3 lineage group.

8. Inoculum comprising the hybrid mushroom culture of claim 1.

9. Mushroom spawn comprising the inoculum of claim 8.

10. Casing inoculant comprising the inoculum of claim 8.

11. Homokaryons derived from the hybrid mushroom culture of claim 1.

12. Mushrooms produced by fruiting of the hybrid mushroom culture of claim 1.

13. A culture of a mushroom strain designated B7970, a representative culture of said mushroom strain having been deposited under ATCC Accession No. PTA-4887.

14. The culture of claim 13, wherein said culture exhibits antagonism toward strains of a Horst U1/U3 lineage group.

15. Homokaryons derived from the culture of claim 13.

16. Inoculum comprising the culture of claim 13.

17. Mushroom spawn comprising the inoculum of claim 16.

18. Casing inoculant comprising the inoculum of claim 16.

19. Mushrooms produced by fruiting of the culture of claim 13.

20. The mushrooms of claim 19, characterized as having a white pileus.

21. The mushrooms of claim 19, characterized as having rounder pileii than pileii of mushrooms produced by cultures from an Agaricus bisporus strain designated A15.

22. The mushrooms of claim 19, characterized as having pileii with thicker flesh than pileii of mushrooms produced by cultures from an Agaricus bisporus strain designated A15.

23. The mushrooms of claim 19, exhibiting lesser symptoms of disease, when co-inoculated with a virus-infected culture of a strain of a Horst U1/U3 lineage group, than exhibited by mushrooms produced by cultures from an Agaricus bisporus strain designated A15.

24. A hybrid mushroom culture of Agaricus bisporus produced by crossing a first culture of Agaricus bisporus with a second culture of Agaricus bisporus, wherein one of said first and said second cultures of Agaricus bisporus is the culture of claim 13 or a strain descended therefrom.
